(19) United States
(12) Patent Application Publication
(10) Pub. No.: US 2004/0108192 A1
(43) Pub. Date: Jun. 10, 2004

(54) Electromotive furniture drive for displacing parts of a piece of furniture in relation to each other

(76) Inventor: Johannes Schneider, Kirchlengern (DE)

Correspondence Address: Robert W Becker & Associates, Suite B, 707 Highway 66 East, Tijeras, NM, 87059, US

(21) Appl. No.: 10/474,706

(22) PCT Filed: Apr. 5, 2002
(86) PCT No.: PCT/EP02/03779

(30) Foreign Application Priority Data
Apr. 10, 2001 (DE) 101 18 015

(51) Int. Cl. H01H 9/02

(52) U.S. Cl. 200/296

(57) ABSTRACT

The invention relates to an electromotive furniture drive for displaying parts of a piece of furniture in relation to each other. Said drive comprises at least two drive units, each drive unit being associated with at least one part of the piece of furniture, in order to displace the same. The furniture drive also comprises a hand switch (2) for actuating the drive units. According to the invention, said hand switch (2) comprises a first operating surface (14), by which means the drive units pertaining to the furniture drive can be successively selected in a first pre-determined order. The inventive furniture drive can be easily operated and has a high level of comfort of use.

The invention relates to an electromotive furniture drive of the type mentioned in the preamble of claim 1 for displacing or adjusting parts of a piece of furniture relative to one another.

Furniture drives of the pertaining type are known in general. They have at least two drive units, whereby each drive unit is associated with at least one part of the piece of furniture for displacing the same. If the furniture drive serves, for example, for the displacement of parts of a lattice structure, a drive unit can be respectively associated with an upper body support part, a head support part, a leg support part and a calf support part of the lattice structure, so that by separate activation of the drive units, the support parts of the lattice structure can be displaced independently of one another. The known furniture drive furthermore has a hand switch for the control of the drive units that for the activation of each drive unit has a pair of push buttons, whereby with activation of one of the push buttons the drive unit displaces the associated part of the lattice structure out of a starting position in the direction toward an end position of the displacement movement, and upon activation of the other push button displaces back in the direction toward the starting position of the displacement movements.

A drawback of the known furniture drive is that its operation via the hand switch is particularly obscure and complicated if the furniture drive is provided with a plurality of drive units in order, for example with the lattice structure, to enable a multiple displacement of the support parts of the lattice structure independently of one another.

It is an object of the invention to provide a furniture drive of the type mentioned in the preamble of claim 1 that does not have this drawback and the operation of which is thus simplified.

This object is realized by the teaching of claim 1.

The invention is freed from the concept that for the control of each drive unit two push buttons need to be provided. Rather, the invention is based on the concept of enabling a successive selection of the drive units of the furniture drive via a single operating surface. For this purpose, the invention provides that the hand switch have a first control or operating surface by means of which the drive units of the furniture drive can be successively selected in a first predetermined sequence for the control or activation.

After selection of the drive unit that is to be activated via the first operating surface, this drive unit can then be controlled by further operating surfaces in such a way that the desired displacement movement is achieved. Since respectively a single drive unit is selected for the control, the further operating surfaces can be used together for the control of all of the drive units.

In this way, the number of the operating surfaces required on the hand switch for the control of the drive units is considerably reduced in comparison to the known furniture drives, so that the operation of the inventive furniture drive is considerably simplified and is made more comfortable.

In the simplest situation, the operation of a plurality of drive units of the furniture drive can be effected with only two operating surfaces, whereby the first operating surface serves for the successive selection of the drive units, and a second operating surface serves for the actuation of the respectively selected drive unit. The control of the respectively selected drive unit can, for example, be effected in such a way that upon activation of the second operating surface the selected drive unit first displaces the part of the piece of furniture associated with it out of a starting position in the direction toward an end position of the displacement movement, and upon reaching the end position and continual activation of the second operating surface displaces the part of the piece of furniture out of the end position of the displacement movement back into the starting position.

The first operating surface, as well as possibly further operating surfaces of the hand switch, can be embodied in any suitable manner, for example on push buttons or some other desired activating elements.

The hand switch can be connected with the drive units that are to be activated via a line, for example a multi-conductor cable, or in a wireless manner, for example via a radio or infra-red connection.

Pursuant to one advantageous further development of the inventive teaching, a second operating surface and a third operating surface are provided, each of which has respectively associated therewith a control function of the respectively selected drive. If the selected drive unit serves, for example, for the raising or lowering of a head support part of a lattice structure, it is possible via the second operating surface to activate, for example, the control function “raise” and via the third operating surface to activate, for example, the control function “lower”.

In principle, it is sufficient if the drive units are successively selectable via the first operating surface in a fixed, predetermined sequence. However, pursuant to one advantageous further development of the inventive teaching, a fourth operating surface is provided by means of which the drive units can be successively selected in a second sequence that is the reverse of the first sequence. In this way, the sequence with which the drive units are successively selected can be reversed. This further improves the comfort of operation, since the respectively desired drive unit can be selected particularly rapidly.

In principle, all of the operating surfaces of the hand switch can be formed on separate control elements, for example on separate push buttons. Pursuant to one advantageous further development, the first operating surface and the fourth operating surface are disposed on the same control element. In this way, the construction of the hand switch is simplified and is hence more economical.

The control element can be embodied in any suitable manner. One extremely advantageous further development provides that the control element be tiltably mounted about a first tilt axis, whereby the first operating surface and the fourth operating surface are oppositely disposed on the control element relative to the first tilt axis in such a way that by tilting the control element toward one side of the first tilt axis and by actuating the first operating surface, the drive units can be successively selected in the first predetermined sequence, and by tilting the control element toward the other side by actuating the fourth operating surface the drive units can be successively selected in the second predetermined sequence. With this embodiment, the control element is embodied similar to a joy stick. This increases the comfort of operation and enables an intuitive control of the furniture drive.

The control functions that can be triggered via the second operating surface and the third operating surface can be any control functions of the drive units. Pursuant to one advantageous further development, the control function that is associated with the second operating surface is a displacement of the part of the piece of furniture that is to be displaced via the respectively selected drive unit out of a starting position in a direction toward an end position of the displacement movement, and the control function that is associated with the third operating surface is a displacement of the part of the piece of furniture that is to be displaced via the respectively selected drive unit in the opposite direction. This further increases the comfort of operation.

The second operating surface and the third operating surface can be disposed in any desired manner relative to the first operating surface or the fourth operating surface, for example being spatially separated therefrom. For example, the operating surfaces can respectively be disposed on a separate push button, whereby the push buttons are spatially separated from one another. Pursuant to one particularly advantageous further development of the inventive teaching, the second operating surface and the third operating surface are disposed on the same control element on which the first operating surface is disposed. With this embodiment, all of the operating surfaces can be disposed on a single control element. In this way, the number of control elements is reduced as much as possible, so that the operation of the inventive furniture drive is particularly straightforward, and the comfort of operation is further increased.

Pursuant to one extremely advantageous further development of the aforementioned embodiment, the control element is tiltably mounted about a second tilt axis, whereby the second and the third control element are oppositely disposed relative to the second tilt axis in such a way that by tilting the control element to one side of the second tilt axis and by actuating the second operating surface, the control function that is associated with this operating surface can be triggered, and by tilting the control element to the other side of the second tilt axis, and by actuating the third operating surface, the control function that is associated with this operating surface can be triggered. With this embodiment, the control element is embodied similar to a joy stick that can be tilted toward four sides, whereby by tilting about the first tilt axis, the drive units are successively selected in the first or second predetermined sequence, and by tilting about the second tilt axis the respectively selected drive is activated. This enables a particularly straightforward and intuitive control.

Pursuant to a further development of the aforementioned embodiment, the second tilt axis is disposed essentially perpendicular to the first tilt axis in such a way that when viewed in plan the operating surfaces are disposed on the control element in an essentially cross-shaped manner.

In conformity with the respective requirements, there can be disposed on the control element a further control surface by means of actuation of which a further control function of at least one of the drive units can be triggered. In this way, the control possibilities of the furniture drive are expanded.

Pursuant to one particularly advantageous further development of the aforementioned embodiment, the further control function is a return of all of the drive units of the furniture drive into a starting position of the displacement movement. For example, if a user has adjusted a lattice structure that is equipped with an inventive furniture drive into a sitting position, and if the user wishes to return the lattice into a sleeping position in which the support parts are provided with a common horizontal support plane, The user can thus reset all of the drive units into their starting position by actuating the further operating or control surface. It is therefore not necessary to separately and successively reset the individual drive units into the starting position of the displacement movement. This way, the comfort of operation is further increased.

Pursuant to a further development of the aforementioned embodiment, the further control surface can be actuated by pressing the control element in a direction perpendicular to the surface thereof. With the embodiment having a control element that is operable similar to a joy stick, the selection and control of the drive units can thus be effected by tilting the control element, whereas a return of the drive units into the starting position is effected by pressing the control element. In this way, the comfort of operation is still further increased.

Pursuant to a further development of the embodiment having the further control surface, this surface, when viewed in plan, is centrally disposed on the control element.

In principle, a straightforward and uncomplicated operation of the inventive furniture drive is furthermore also possible without visual controls regarding which drive unit has been selected. To enable a visual control, pursuant to a further development an indicator is provided by means of which can be indicated which of the drive units is respectively selected.

With the aforementioned embodiment, by means of the indicator the piece of furniture can be at least partially schematically illustrated, whereby via indicator markings the arrangement of the drive units on the piece of furniture can be illustrated. In this way, the operation of the inventive furniture drive is simplified still further, since the spatial association of the drive units to the parts of the piece of furniture that are to be displaced are indicated to the user.

Pursuant to a further development of the aforementioned embodiment, the indicator markings are formed by light-emitting diodes.

The invention will be described in greater detail subsequently with the aid of the accompanying drawing, in which embodiments of a hand switch of an inventive furniture drive are illustrated.

The drawing shows:

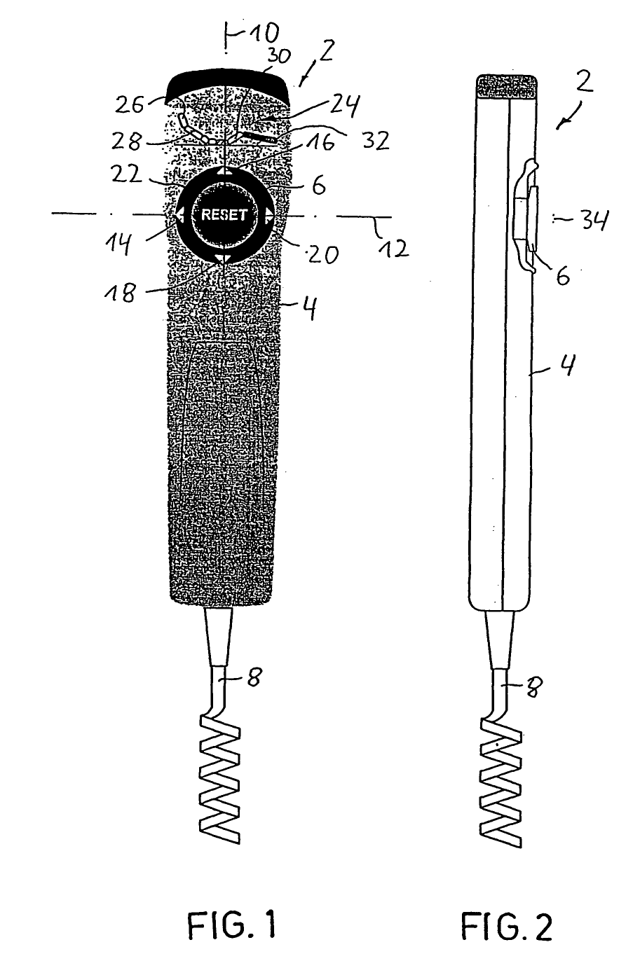

FIG. 1 a schematic plan view onto a first embodiment of a hand switch of an inventive furniture drive,

FIG. 2 a side view of the hand switch of FIG. 1,

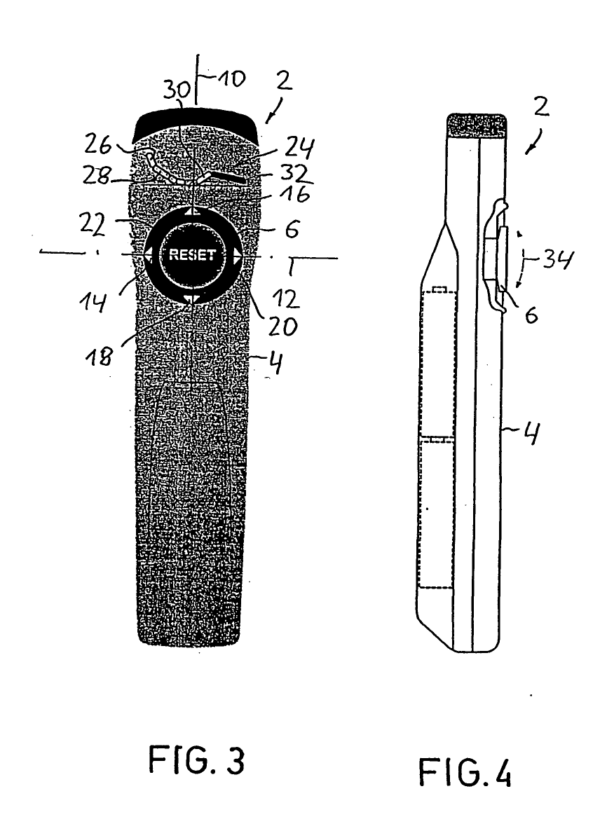

FIG. 3 in a comparable illustration to that of FIG. 1, a second embodiment of a hand switch of an inventive furniture drive,

FIG. 4 in a comparable illustration to that of FIG. 2, the furniture drive of FIG. 3, and

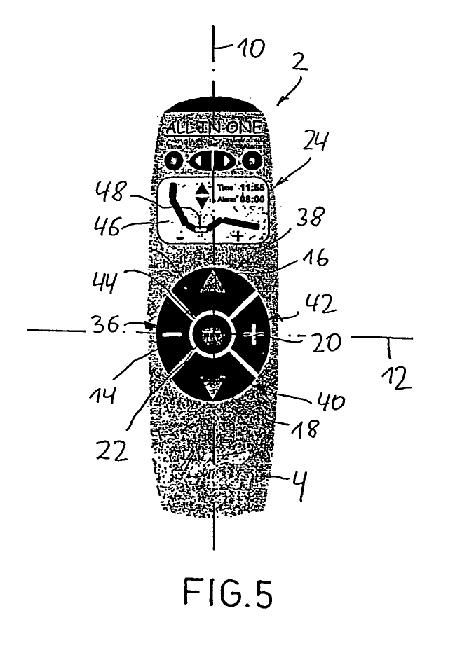

FIG. 5 in a comparable illustration to that of FIG. 1, a third embodiment of a hand switch of an inventive furniture drive.

In the figures of the drawings, the same or corresponding components have the same reference numerals.

Illustrated in FIG. 1 is one embodiment of a hand switch 2, of an inventive furniture drive, that serves for controlling a plurality of drive units of the furniture drive, which drive units are not illustrated in the drawing. The drive units can serve, for example, for the independent adjustment or displacement of support components of a lattice structure, for example of a head support part, an upper body support part, a leg support part and a calf support part.

The hand switch 2 has a housing 4 in which is disposed an electrical or electronic switching unit that can be operated by means of a control element 6 and is connected via a multi-conductor cable 8 with the drive units for the control thereof.

In this embodiment, the control element 6 is pivotably mounted about a first tilt axis 10, which in FIG. 1 is symbolized by a dot-dash line 10, and about a second tilt axis 12, which in FIG. 1 is symbolized by a dot-dash line 12, whereby the second tilt axis 12 extends essentially perpendicular to the first tilt axis 10.

Formed on the control element 6 are a first operating surface 14, a second operating surface 16, a third operating surface 18 and a fourth operating surface 20, whereby the first operating surface 14 and the second operating surface 20 are oppositely disposed relative to the first tilt axis 10, and the second operating surface 16 and the third operating surface 18 are oppositely disposed relative to the second tilt axis 12. From the drawing it can be seen that the operating surfaces 14, 16, 18, 20 are disposed on the control element 6 in the manner of a cross. The control element 6 is furthermore provided with a further operating surface 22, which is centrally disposed on the control element 6.

Pursuant to the invention, by means of the first operating surface 14 the drive units of the furniture drive can be successively selected in a first predetermined sequence. If the furniture drive is provided, for example, with four drive units, of which respectively one serves for the displacement of a head support part, one for an upper body support part, one for a leg support part, and one for a calf support part, then the drive units can, for example, be selected by the first operating surface 14 for example in the sequence “calf support part-leg support part-upper body support part-head support”.

By means of the fourth operating surface 20, the drive units can be selected in a second sequence in reverse to the first sequence, in other words, for example in the sequence “head support part-upper body support part-leg support part-calf support part”.

For the control of the respectively selected drive units, the second support surface 16 and the third support surface 18 have respectively associated therewith a control function of the drive unit. For example, the second operating surface 16 can have associated therewith the control function “raise” and the third support surface 18 can have associated therewith the opposite control function “lower”.

By pressing the control element 6 into the plane of the drawing in FIG. 1 at the further support surface 22, a further control function can be triggered, which with this embodiment comprises a return of all of the drive units of the furniture drive into a starting position of the displacement movement.

With this embodiment, the hand switch 2 is furthermore provided with an indicator 24 by means of which it can be indicated which of the drive units is respectively selected. In this embodiment, the indicator 24 essentially comprises light-emitting diodes 26, 28, 30 and 32, whereby the light-emitting diode 26 symbolizes the head support part, the light-emitting diode 28 symbolizes the upper body support part, the light-emitting diode 30 symbolizes the leg support part and the light-emitting diode 32 symbolizes the calf support part of the lattice structure, and by illumination of the respective light-emitting diode 26, 28, 30, 32 indicates that the drive unit associated with the respective support part is selected.

The inventive furniture drive functions as follows:

If the support parts of the lattice structure are in a starting position of the displacement movement, in which they provide a common, horizontal support plane, and if the user wishes, for example, to adjust the calf support part, he or she then first selects the drive unit associated with the calf support part. If in so doing, for example, the drive unit associated with the head support part is first selected, which is indicated by illumination of the light emitting diode 26, the user then selects the drive unit associated with the calf support part such that he or she tilts the control element 6 about the first tilt axis 10 by pressing down on the operating surface 20 three times until the selection of the drive unit associated with the calf support part is indicated by illumination of the light emitting diode 32.

After the selection of this drive unit, the user tilts the control element 6 about the second tilt axis 12 by pressing down the control element 6 at the second operating surface 16. As a consequence, the drive unit associated with the calf support is activated and raises the calf support part in the desired manner. When the desired adjustment position is achieved, the user releases the control element 6. In a corresponding manner, the drive units associated with the further support parts can be selected, and in particular either in the first predetermined sequence by actuating the first operating surface 14, or in the second predetermined sequence by actuating the fourth operating surface 20. After selection of the desired drive unit, the latter can be activated by means of the second operating surface 16 and the third operating surface 18 for carrying out the desired adjustment movement, whereby the control function “raise” is triggered by the second operating surface 16, and the control function “lower” is triggered by the third operating surface 18.

If the user wishes to return all of the drive units into the starting position of the adjustment movement, in which the support parts of the lattice structure provide a common horizontal support plane, he or she presses down the further control surface 22 of the control element 6. As a consequence, all of the drive units are activated such that the support parts of the lattice structure are displaced back into the starting position.

The hand switch 2, via a single control element 6 that is embodied similar to a joy stick, thus enables a control of a plurality of drive units of the furniture drive. In this way, operation of the furniture drive is considerably simplified and is intuitively designed, thus considerably increasing the comfort of operation. Due to the fact that only a single control element 6 is required, the inventive hand switch 2 is straightforward and hence economical to manufacture.

FIG. 2 shows a side view of the hand switch 2 of FIG. 1, whereby the double arrow 34 symbolizes that the control element 6 is mounted on the hand switch 2 in such a way as to be tiltable about the second tilt axis 12.

In FIG. 3, a further embodiment of an inventive hand switch 2 is illustrated that differs from the embodiment of FIG. 1 in that the transmission of control signals from the hand switch 2 to the drive units is not effected over a cable, but rather in a wireless manner, for example via a radio or infra-red connection.

In FIG. 5, a third embodiment of an inventive hand switch 2 is illustrated that initially differs from the embodiment of FIG. 3 in that the operating surfaces 14, 16, 18, 20 are respectively formed on a separate push button 36, 38, 40, 42, whereby the push buttons 36, 38, 40, 42, are arranged in a cross-shaped manner. Disposed centrally between the push buttons 36, 28, 40, 42 is a further push button 44 on which is formed the further control surface 22.

The indicator 24 in this embodiment is formed by an LCD display 46, on which the lattice structure with its support parts is schematically illustrated; and by means of a light bar 48 there is indicated which drive unit is respectively selected.

Also with the embodiment of FIG. 5 a simple and intuitive operation is made possible, and hence a high comfort of operation is achieved.

1. Electromotive furniture drive for the displacement of parts of a piece of furniture relative to one another,
with at least two drive units, whereby each drive unit is associated with at least one part of the piece of furniture for displacing the same, and
with a hand switch for the activation of the drive units,
characterized in that,
the hand switch (2) is provided with a first operating surface (14), by means of which the drive units of the furniture drive can be successively selected in a first predetermined sequence.

2. Furniture drive according to claim 1, characterized by a second operating surface (16) and a third operating surface (18), each of which has respectively associated therewith a control function of the respectively selected drive unit.

3. Furniture drive according to claim 2, characterized by a fourth operating surface (20), by means of which the drive units can be successively selected in a second sequence that is the reverse of the first sequence.

4. Furniture drive according to claims 1 and 3, characterized in that the first operating surface (14) and the fourth (20) operating surface are disposed on the same control element (6).

5. Furniture drive according to claim 4, characterized in that the control element (6) is tiltably mounted about a first tilt axis (10), whereby the first operating surface (14) and the fourth operating surface (20) are oppositely disposed on the control element (6) relative to the first tilt axis (10) in such a way that by tilting the control element (6) to one side and by actuating the first operating surface (14), the drive units can be successively selected in the first predetermined sequence, and by tilting the control element (6) to the other side and by actuating the fourth operating surface (20), the drive units can be successively selected in the second predetermined sequence.

6. Furniture drive according to claim 2, characterized in that the control function associated with the second operating surface (16) is a displacement of the part of the piece of furniture that is to be displaced via the respectively selected drive out of a starting position in the direction toward an end position of the displacement movement, and the control function associated with the third operating surface (18) is a displacement of the part of the piece of furniture that is to be displaced via the respectively selected drive in the opposite direction.

7. Furniture drive according to claim 2, characterized in that the second operating surface (16) and the third operating surface (18) are disposed on the same control element (6) on which the first operating surface (14) is disposed.

8. Furniture drive according to claims 5 and 7, characterized in that the control element (6) is tiltably mounted about a second tilt axis (12), whereby the second operating surface (16) and the third operating element (18) are oppositely disposed relative to the second tilt axis (12) such that by tilting the control element (6) to one side of the second tilt axis (12), and by actuating the second operating surface (16), the control function that is associated with this operating surface (16) can be triggered, and by tilting the control element (6) to the other side of the second tilt axis (12), and by actuating the third operating surface (18), the control function associated with this operating surface (18) can be triggered.

9. Furniture drive according to claim 8, characterized in that the second tilt axis (12) extends essentially perpendicular to the first tilt axis (10) such that the operating surfaces (14, 16, 18, 20), when viewed in plan, are disposed in an essentially cross-shaped manner on the control element (6).

10. Furniture drive according to claim 1, characterized in that a further operating or control surface (22) is disposed on the control element (6) by actuation of which a further control function of at least one of the drive units can be triggered.

11. Furniture drive according to claim 10, characterized in that the further control function is a return of all of the drive units of the furniture drive into a starting position of the displacement movement.

12. Furniture drive according to claim 10, characterized in that the further control surface (22) can be actuated by pressing the control element (6) in a direction perpendicular to the surface thereof.

13. Furniture drive according to claim 10, characterized in that the further control surface (22), when viewed in plan, is centrally disposed on the control element (6).

14. Furniture drive according to claim 1, characterized by an indicator (24), by means of which can be indicated which of the drive units is respectively selected.

15. Furniture drive according to claim 14, characterized in that by means of the indicator (24), the piece of furniture can be at least partially schematically illustrated, and in that by means of indicator markings, the arrangement of the drive units on the piece of furniture can be illustrated.

16. Furniture drive according to claim 15, characterized in that the indicator markings are formed by light-emitting diodes (26, 28, 30, 32).
